(19) United States
(12) Patent Application Publication
(10) Pub. No.: US 2025/0334667 A1
(43) Pub. Date: Oct. 30, 2025

(54) RADAR STIMULATION SYSTEM EMPLOYING I-Q BASEBAND SIGNAL PROCESSING IN RADAR RETURN GENERATOR

(71) Applicant: Textron Systems Corporation, Hunt Valley, MD (US)

(72) Inventor: James Joseph Jaklitsch, Parkton, MD (US)

(21) Appl. No.: 19/187,183

(22) Filed: Apr. 23, 2025

Related U.S. Application Data
(60) Provisional application No. 63/640,422, filed on Apr. 30, 2024.

(51) Int. Cl. G01S 7/282; G01S 7/02; G01S 7/288

(52) U.S. Cl. CPC G01S 7/282; G01S 7/023; G01S 7/2886

(57) ABSTRACT

A radar stimulation system generates an intermediate-frequency (IF) radar return waveform for a radar receiver of a radar system under test (RUT) by applying down-conversion processing to a transmit IF pulse signal of the RUT to generate a transmit-side baseband I-Q signal having I-Q phasor signal samples with in-phase and quadrature components. I-Q convolutional processing is applied to the transmit-side baseband I-Q signal and synthesized net resultant vector (NRV) range traces to produce a return-side baseband I-Q signal, the synthesized net resultant vector (NRV) range traces representing a predetermined simulated radar scene, the convolutional processing including range-bin multiplexing of I-Q samples of the NRV range traces and I-Q finite-impulse-response (FIR) filtering using the I-Q phasor signal samples as filter coefficients. Up-conversion processing is applied to the return-side baseband I-Q signal to produce the synthesized IF radar return waveform.

### BACKGROUND

The invention is generally in the field of radar training systems, and relates specifically to radar return generators used in radar training systems.

### SUMMARY

Described herein is a Universal Radar Return Generator generally capable of producing high-fidelity stimulation for any mode of any type of radar. It can be used in connection with testing airborne, multi-mode radars as well as circular-scan radars for crew training application, applying a generalized methodology for generating radar return signals for environments of arbitrary complexity.

The disclosed methods and apparatus address a challenge in modern pulse compression radar in which return signals are massively overlapped in time. While there are known techniques based on use of finite impulse response (FIR) filtering, these suffer from certain distortion especially in phase. This limitation is particularly problematic in the context of airborne (mobile) multi-mode radars that rely on accurate processing of differential Doppler to generate radar images.

The disclosed technique can avoid the problems of known radar signal synthesis approaches by use of a processing technique enabling impulse signals to be represented in a single non-zero sample that specifies both amplitude and phase, e.g., as a I-Q phasor having in-phase (I) and quadrature (Q) components. This approach enables accurately conveying phase information while much more accurately approximating true impulses (theoretically having zero width in time), enabling high-fidelity stimulation for any mode of any type of radar.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views.

FIG. 1 is a block diagram of a test setup including a radar under test (RUT) and a radar stimulation system;

FIG. 2 is a waveform diagram of a transmit IF radar pulse signal;

FIG. 3 is a waveform diagram of a compressed radar return signal;

FIG. 4 is a plot illustrating an In-phase/Quadrature (I-Q) signal;

FIG. 5 is a schematic illustration of a set of range bins as corresponding to radar returns in a physical environment;

FIG. 6 is a matrix illustrating range-bin processing for Doppler-based segregation of different reflectors;

FIGS. 7 and 8 are plots of frequency spectra for a baseband I-Q signal at one and two samples per range bin, respectively;

FIG. 9 is a schematic diagram of channel circuitry for one channel of a multi-channel radar return generator;

FIG. 10 is a schematic diagram of a convolution processor of the channel circuitry;

FIG. 11 is a schematic diagram of a net resultant vector (NRV) generator of the channel circuitry;

FIG. 12 is a schematic diagram of Multiple Time Around (MTA) processing circuitry of the channel circuitry;

FIGS. 13A-13D are waveform diagrams of input-side reference pulses (IF and I-Q baseband) in the channel circuitry;

FIGS. 14A-14C are waveform diagrams (baseband I channel, compressed return amplitude, and compressed return phase) for a first simple target in range bin 1, 0° phase;

FIGS. 15A-15C are waveform diagrams (baseband I channel, compressed return amplitude, and compressed return phase) for a second simple target in range bin 100, 180° phase;

FIGS. 16A-16C are waveform diagrams (baseband I channel, compressed return amplitude, and compressed return phase) for a first simple target in range bin 100, 60° phase;

FIGS. 17A-17C are waveform diagrams (baseband I channel, compressed return amplitude, and compressed return phase) for a set of five time-overlapped targets;

FIGS. 18A-18C are waveform diagrams (baseband I channel, compressed return amplitude, and compressed return phase) for a first test pattern of targets having sine-wave amplitude and phase ramp;

FIGS. 19A-19C are waveform diagrams (baseband I channel, compressed return amplitude, and compressed return phase) for a second test pattern of targets having exponential decaying amplitude and phase ramp;

FIGS. 20A-20D are waveform diagrams (baseband | channel, baseband Q channel, compressed return amplitude, and compressed return phase) for a third test pattern illustrating moving target indication (MTI) Doppler with Distributed Target Synthesis.

### DETAILED DESCRIPTION

FIG. 1 shows a radar testing or simulation environment in which a radar stimulus (STIM) system 10 is used in connection with a radar under test (RUT) 12. As shown, the radar stimulus system 10 includes a radar return generator (RRGEN) 14 that receives transmit intermediate-frequency signals (TX IFs) 16 from the RUT 12 and generates receive IF signals (RX IFs) 18 provided back to the RUT 12. The RUT 12 typically includes exciter circuitry (EXC′R) 20, receiver circuitry (RCV′R) 22, and radio-frequency and antenna circuitry and components (RF & ANT) 24. In regular (non-testing) use of the RUT 12, the exciter circuitry 20 generates the TX IFs 16, which are supplied to the RF & ANT 24 for generating and transmitting RF pulses, while the receiver circuitry 22 operates upon receive IFS produced from RF return pulses received and processed by the RF & ANT 24. In a testing setup as shown, the RF & ANT 24 is effectively bypassed (and thus shown in dashed lines here)—the radar stimulator system 10 operates upon the TX IFs 16 and produces synthesized RX IFs 18 for processing by the receiver circuitry 22.

FIG. 1 assumes a known “monopulse” type of radar system that employs a set of multiple distinct RF signals and related RF beam processing. Thus, the RRGEN 14 is shown as having four processing channels for respective IF signals, namely a sum (Σ) channel 26, delta azimuth (Δ AZ) channel 28, delta elevation (Δ EL) channel 30, and a guard channel 32. In the description below, details of structure and processing are given for a single channel, and it will be understood that in a multi-channel system such structure and processing are generally replicated for each of the channels.

Generally, the radar stimulation system 10 is used to synthesize and provide the RX IFs 18 containing signal patterns representing test “scenes” typically containing target(s) of interest along with “clutter”. This enables operations such as evaluation of receiver functionality, training and testing of radar operators, etc. Data representing such scenes are provided in the form of input waveform data, as mentioned below. Simplified abstracted examples are also provided below. Techniques for generating appropriate waveform data to represent scenes of interest are generally known and not elaborated herein.

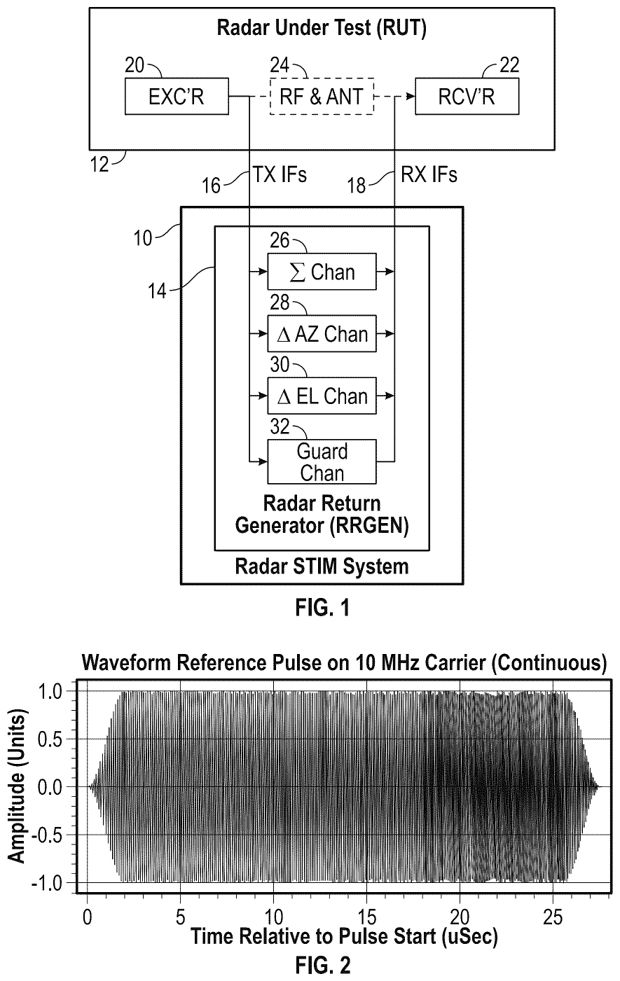

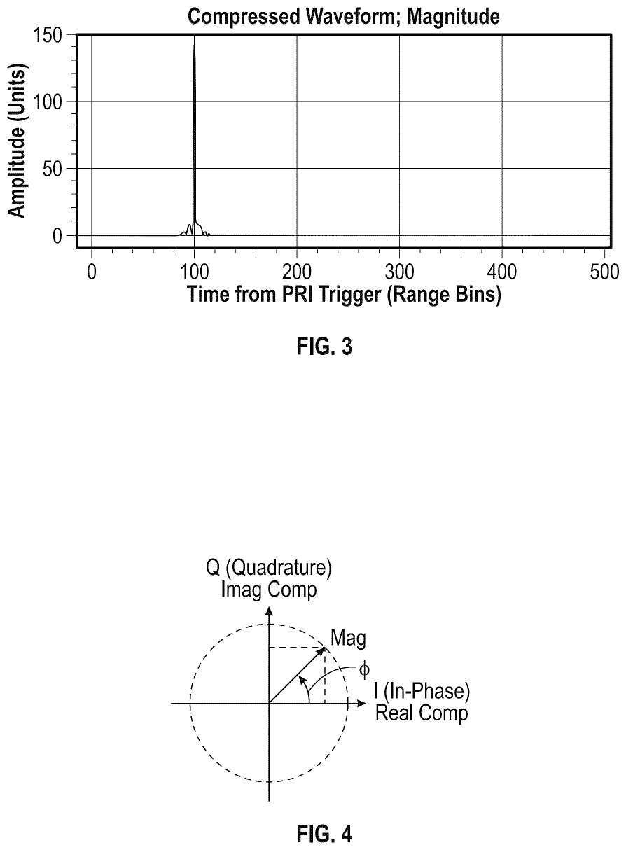

FIGS. 2 and 3 illustrate an aspect of challenge of the processing in pulse-compression radar. Modern radars use pulse compression to provide higher effective power in the radar transmit waveform (i.e., longer detection range) than would be possible if the transmit pulse width were limited to the temporal duration of a single range bin. FIG. 2 shows an example transmit pulse, which is fairly long in duration (e.g., 25.6 μS) and is encoded with some type of auto-correlation coding (e.g., an FM chirp, 2.9 MHz bandwidth). The auto-correlation coding is typically FM, but can also be various types of phase modulation. In the radar receiver, the return waveform is passed through a matched filter that is effectively performing an auto-correlation of the transmit waveform, and at the range that correlation is achieved, all of the waveform energy piles up in a single range bin, illustrated by the single short-duration pulse in FIG. 3. The pulse compression ratio is the time-bandwidth product, which in this example is 25.6 μS×2.9 MHz=74.24. In other words, the radar transmit pulse (FIG. 2) is 74.24 times as wide as the compressed pulse (FIG. 3), which, by definition, occupies a single range bin.

The implication for a system tasked with generating high-fidelity radar return signals is that distributed returns are massively overlapped in time. In order for a stimulator (e.g., stimulator 10) to place a controlled signal in each range bin, the return signal must consist of the summation of numerous individual signals (e.g., 74 in this simple case), each delayed in time by an amount corresponding to the range bin of interest, and each needing independent control of magnitude and phase as required to simulate specific environmental effects. It should also be understood that in many real systems, such as search radars, it is not uncommon to have pulse compression ratios as high as 1,000:1. So one significant issue is how to best deal with massive time-overlap of a large number of radar return signals without exploding the complexity of the radar return signal generation hardware.

Prior known radar stimulation systems include a Target and Clutter Stimulus Unit (TCSU) and a Radar Environment Simulator (RES). These have provided different tradeoffs between fidelity and comprehensiveness. The TCSU approach provides exacting fidelity that is capable of testing virtually any type of radar signal processing, because it is true to physics. But TCSU has a significant limitation with the number of point targets that can be generated, and is therefore unsuitable for generating range-distributed radar returns. RES has a fairly ingenious solution to producing range-distributed radar returns, but a deviation from strict mathematical theory compromises the fidelity of the simulation. The loss of fidelity is not noticeable in some applications such as shipboard and land-based radars, but RES does not have the precision to properly stimulate airborne multi-mode radars that employ fine processing of differential Doppler to generate radar images.

The presently disclosed radar stimulation technique employs convolutional synthesis of radar returns in a manner that avoids limitations of prior techniques, enabling application to more advanced systems such as airborne radar. In particular, the technique is based on use of a certain type of impulse signal to stimulate the waveform synthesis filter for each range bin, namely a single non-zero sample that specifies both magnitude and phase. In other words, the impulse is the equivalent of a single-sample phasor having in-phase (I) and quadrature (Q) components, an example of which is shown in FIG. 4. Such an I-Q phasor enables the specification of both magnitude and phase with a single sample, which is critical for accurately representing a true impulse (i.e., zero width in time).

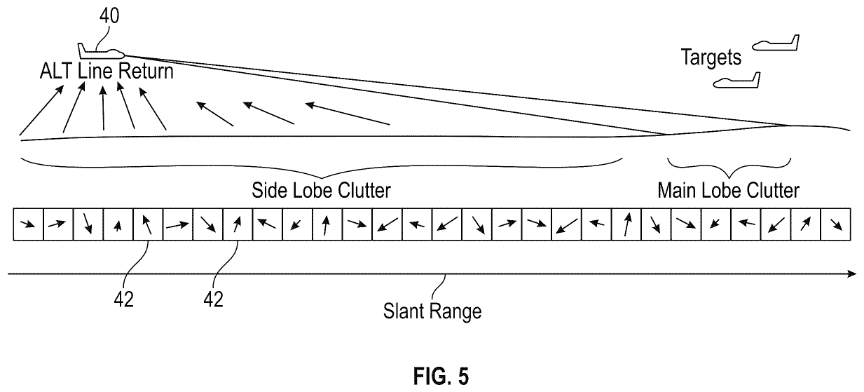

FIG. 5 is a schematic diagram used to illustrate the notion of range bins in radar systems. In this example a radar system is located in an airborne platform 40. Return signals from the environment are shown, including side-lobe clutter and main-lobe clutter. The so-called slant range is depicted as extending forward from the platform 40, divided into units called “range bins” 42 corresponding to respective delay times for the return signals. This diagram helps illustrate that the convolutional synthesis of radar returns from a true (i.e., single sample) I-Q impulse is effectively the inverse of what the radar is doing. Each time the radar transmits a pulse, it begins sampling in δt increments in time, where δt is the time corresponding to the temporal width of a single range bin 42. The samples are collected as I-Q phasors (shown as vectors of arbitrary phase in the range bins 42), so the radar is collecting exactly one I-Q phasor from each range bin each time the radar transmits.

The collected I-Q phasor for each range bin 32 is the vector summation, after pulse compression, of all of the individual reflections at that range, weighted by the transmit/receive antenna pattern and 1/R⁴ range loss. In other words, it is the Net Resultant Vector (NRV) from the individual contributions of every reflector at a range corresponding to the specific range bin of interest. In a typical use case, there could be as many as hundreds of individual reflectors at each range, each represented by its own I-Q phasor. Further, every one of those individual I-Q phasors (reflectors) is, in general, rotating with its own Doppler, because the line-of-sight Doppler is weighted by Cosine [Az] Cosine [El], where Az and El angles (Own-ship to reflector) are unique to each reflector.

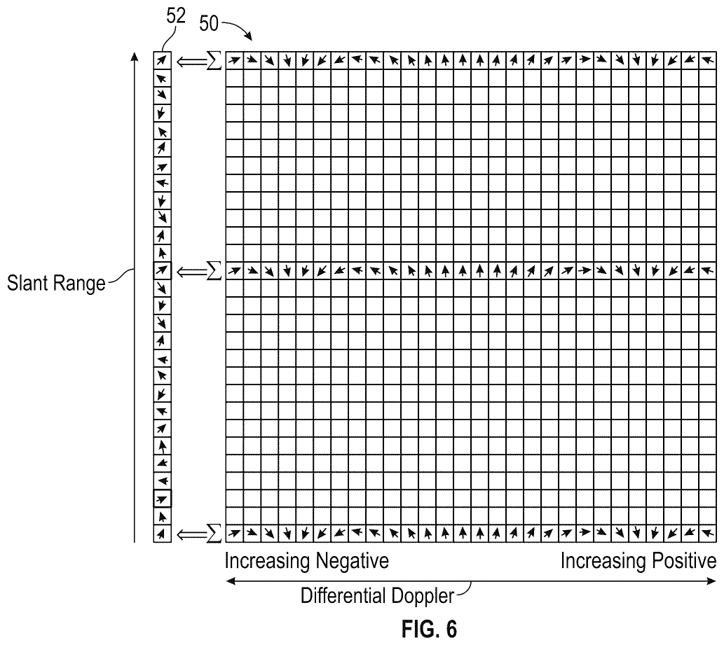

FIG. 6 illustrates a Range-Doppler map 50 that is used by a radar system to make sense out of a large number of individual reflectors, each with its own differential Doppler, which sum together to form a single Net Resultant Vector (NRV) in each range bin. Processing is based on exploiting the behavior, over time, of the NRVs in each range bin. On each successive radar pulse, the NRV in each range bin changes. The radar system uses the map 50 to keep a history over time of each NRV at each range, and uses a Fourier Transform to isolate the different Dopplers in each range bin. In this map 50, each row of the map 50 corresponds to a respective range bin, while each column corresponds to a specific differential Doppler frequency (from negative through zero to positive, as shown). The radar system generates the map 50 by processing a series of range traces, each of which is the set of NRVs collected from all range bins as a result of a single transmitted radar pulse. A single range trace 52 is shown at left. The radar computes the individual pixels within each row by running a complex Discrete Fourier Transform (DFT) on the set of NRVs collected from the corresponding range bin, over a series of range traces 52.

Thus, the Radar Return Generator 14 causes arbitrary scenes to be created in the radar processing by causing the correct set of NRVs to appear in each range bin of each range trace. The challenge is for the RRG 14 to reliably cause accurate NRVs to appear in each range bin for each transmission of a radar pulse by the RUT 12.

Referring again to FIG. 1, the radar return generator 14 operates “behind” the RF & antenna 24, i.e., it operates on the TX IFs 16 from the exciter 20 and injects return signals in the form of RX IFs 18 into the receiver 22, bypassing the RF and antenna functions 24 of the RUT 12. Among other benefits, this arrangement provides for use of spatial diversity to effectively render a radar scene. Because the point of signal injection is behind the radar antenna array, the Radar Return Generator 14 needs to emulate the function of the antenna array, which converts incoming RF signals into the four IF channels (Sum Channel 26, Delta Elevation Channel 30, Delta Azimuth Channel 28, and Guard Channel 32). This function, i.e., Antenna Beam Forming, allows the radar to form Discriminants (i.e., Delta/Sum) that measure the Azimuth and Elevation angles to the reflectors from a single pulse. Antenna beamforming also allows the radar to perform sidelobe cancellation by checking to verify the return for a given reflector in the Sum Channel 26 is greater than the corresponding return in the Guard Channel 32. The radar return generator 14 mimics this functionality by using four identical processing channels (26-32) for which the I-Q vector corresponding to each individual reflector is weighted in each channel by the applicable antenna pattern (prior to being summed into the NRV).

Within each channel, performing accurate (i.e., full fidelity) Radar Return Generation for any mode of an advanced airborne multimode radar logically subdivides into a Convolutional Synthesis Function and a Net Resultant Vector (NRV) Generation Function. The Convolutional Synthesis Function is tasked with generating the time-overlapped radar return signals from a Range Trace of NRVs (i.e., the set of NRVs (One per Range Bin) that are present in each radar range bin as a result of each transmitted radar pulse). The NRV Generation Function is tasked with executing a scenario and computing the correct Net Resultant Vector (NRV) in each range bin of the Range Trace, on a pulse by pulse basis.

### Sample Rate Considerations

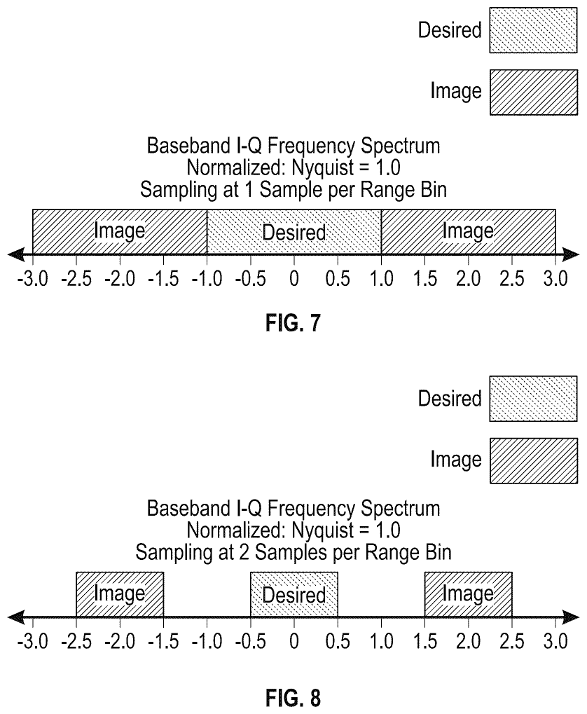

FIGS. 7 and 8 are used to illustrate certain key aspects underpinning the per-channel processing which is described in detail further below, namely the use of two (2) samples per range bin, including zero insertion, to achieve several objectives. Generally, an I-Q data stream is decimated to produce an exact integer number of samples (2 or more, but at least 2) per range bin period, and not one sample as might be considered based purely on accuracy (pure pulse representation). This is driven by the relationship between the range bin temporal width (i.e., duration), the modulation bandwidth, and the Nyquist sample rate.

The concept of an exact integer number is driven by the need to control the I-Q vectors that appear in each range bin of the Radar Under Test 12. The sample rate should synchronize with the range bin sample rate, not roll through it, as would occur if non-integer ratio were to be permitted.

Additionally, FIGS. 7 and 8 depict the need for a minimum of 2 samples per range bin, driven by the need to up-sample and reconstruct the Radar Return Signal. FIG. 7 shows the spectrum for a baseband I-Q signal with only one sample per range bin, which does not provide enough separation between the desired signal (“Desired”) and its images (“Image”) in sampled data space. M ore specifically, in one specific example the radar pulse width (PW) is 25.6 μSec, the coding is FM Chirp, and the bandwidth is 2.9 MHz (Ref: FIGS. 2.1-1). This implies that the range bin temporal width is 1/(2.9 MHz), which is the compressed pulse width. FIG. 7 shows the spectral implications, on a normalized frequency scale in which 2.0 is the sample rate (2.9 MHz), and 1.0 is the Nyquist Rate. At 1 sample per range bin (FIG. 7), the sample rate (2.0) is exactly 2× the highest frequency in the baseband waveform (1.0). This causes the desired signal (Desired) to abut (line-to-line) against its undesired spectral image (Image). While the signal is not aliased, there is no separation between the desired signal and the undesired image. Such a signal cannot be accurately up-sampled, because an infinitely sharp filter would be required to pass the desired signal and filter out the image.

FIG. 8 shows the situation when the sample rate is increased to 2 samples per range bin (e.g., 5.8 MHz sample rate in this example). At 2 samples per range bin, the sample rate (2.0) is exactly 4× the highest frequency in the baseband waveform (1.0), which provides sufficient separation between the desired signal (Desired) and its undesired spectral image (Image) to enable up-sampling and filtering as needed.

Thus while a higher sample rate is needed, at the same time there are problems with trying to use multiple signal samples to approximate a true unit impulse (which is a source of inaccuracy in prior techniques). The problems include so-called “Zero Order Hold” distortion effects, which can significantly degrade the compression response. The solution is to use multiple (e.g., 2) samples per range bin, but only 1 of which may be non-zero. Thus in one example, the impulse vector is a 2-sample vector {I-Q, 0}, wherein the 1st sample is the sampled I-Q data, and the 2nd sample is always zero. This approach preserves the mathematical integrity of a true impulse (i.e., no “zero order hold”) while also achieving the spectral separation necessary for accurate up-sampling and filtering (e.g., 2 samples per range bin).

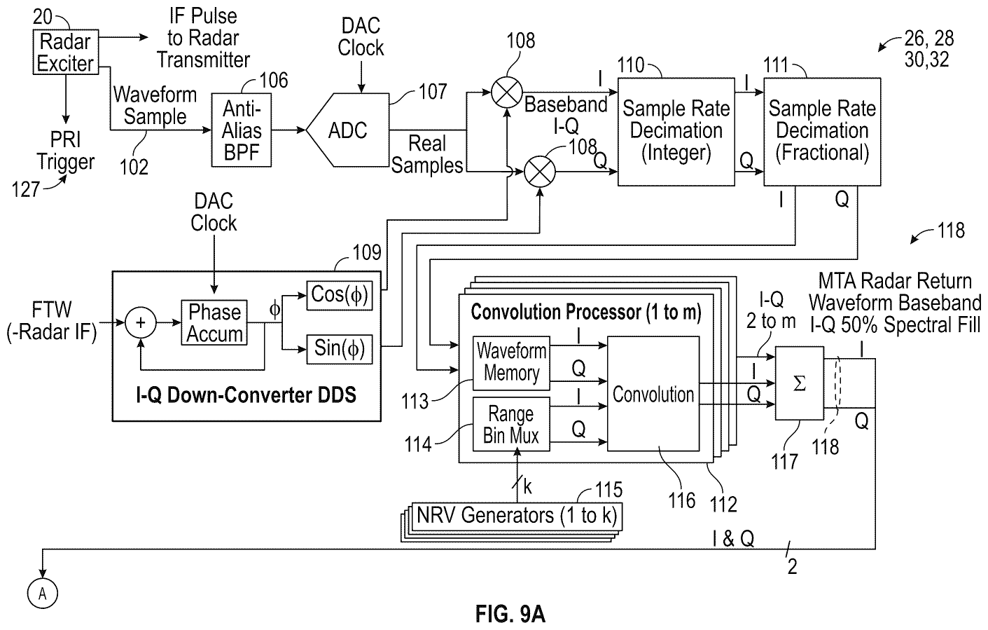

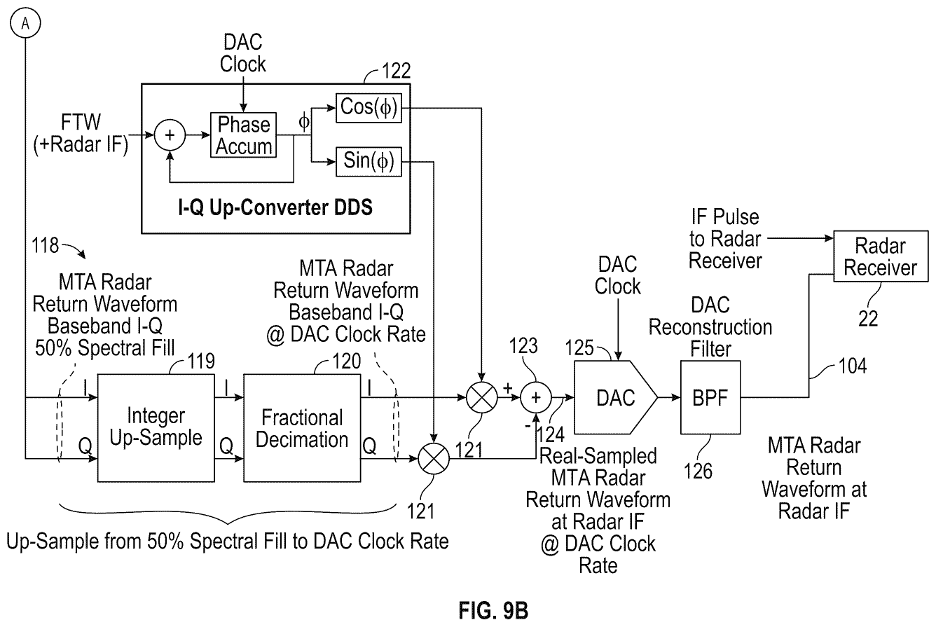

FIG. 9 shows the organization of a single channel (e.g., one of 26, 28, 30 or 32) of the Radar Return Generator 14. The processing is performed entirely in the digital domain, except for analog filtering (106, 126) and analog/digital conversion (107, 125) at input and output respectively.

As shown, a Waveform Sample 102 (of a TX IF signal 16 in FIG. 1) is coupled off the Radar Exciter 20, then filtered 106 to preclude digital aliasing before being digitized by an Analog to Digital Converter (ADC) 107. The samples out of the ADC 107 are real-valued, and are down-converted to baseband I-Q by digitally mixing them 108 with an I-Q Down-Converter Direct-Digital Synthesizer (DDS) 109 that is tuned to (i.e., Phase-Locked with) the Radar IF Frequency. The I-Q Down-Converter DDS 109 has Cosine and Sine outputs that down-convert the radar IF to DC, with In-phase (I) and Quadrature (Q) components of modulation, respectively (i.e., Baseband I-Q, at the ADC sample rate).

The Baseband I-Q data stream, at the ADC sample rate, is Decimated (110 and 111) to produce an exact integer number of samples (2 or more, but at least 2) per range bin period (as described above). Because there is not, in general, and exact integer relationship between the ADC sample rate and the range bin period, the Decimation (reduction in sample rate) consists of an Integer part (110) and a fractional part (111). The output of the decimation process is a sample rate that is an exact integer multiple (2× or higher) of the range bin sampling rate (i.e., 1/range bin period). Baseband I-Q data at this sample rate is clocked into a Waveform Memory (113) of a Convolution Processor (112) on each PRI Trigger (127) received from the Radar Exciter 20. As shown, a set of m Convolution Processors 112 is used in parallel fashion for Multiple Time A round (MTA) processing as described below.

The Convolution Processor (112) synthesizes the radar return signal, at baseband I-Q, by convolving the Net Resultant Vector (NRV) for each range bin with the Waveform Memory (113). A convolution function (116) clocks at the decimated sample rate (i.e., exact integer multiple (2× or higher) of the range bin sampling rate). The NRV for each range bin is produced by a series of NRV Generators (115), with the series consisting of 1 per range bin (i.e., 1 through k NRV Generators to cover k range bins). The k NRV Generators (115) are multiplexed into the Convolution (116) by a Range Bin Multiplexer (Mux) (114).

The Range Bin Mux (114) serves the dual function of routing the NRV for each range bin, in turn, into the Convolution (116), and also placing at least one zero-magnitude I-Q sample between every NRV (zero insertion). This is done to the independent mathematical constraints as described above, i.e., to provide an integer number 2 or more samples with at most one being non-zero, in each range bin.

In general, there are a multiple m parallel Convolution Processors (112) to implement Multiple Time A round (MTA) processing. In this context, MTA processing refers to the fact that the radar may retransmit prior to the time required for the return signals from the longest range to reach the radar receiver (e.g., Medium or High PRF Radar modes). The amount of parallelism required is established by the maximum number of radar pulses, m, that are “In the air” at any given time. Thus, a total of m parallel Convolution Processors (112) are required. The outputs (Baseband I-Q waveforms at the Decimated sample rate are summed (17) to produce the MTA Radar Return Waveform.

The MTA Radar Return Waveform, at the baseband I-Q (i.e., Decimated) sample rate, is up-sampled (119 and 120) to return the I-Q sample rate to the DAC Clock Rate. Because there is not, in general, an exact integer relationship between the DAC/ADC sample rate and the sample rate through the Convolution Processor (112), the up-sample process (119, 120) consists of an Integer Up-sample (119) and a Fractional Decimation (120). The Up-sample (119) is the smallest integer ratio that produces an I-Q sample rate higher that the DAC Clock. The Fractional Decimation (120) reduces the I-Q sample rate to match the DAC Clock.

At the output of the Fractional Decimation 120, the MTA Radar Return Waveform is a Baseband I-Q data stream at the DAC Clock rate. It is digitally mixed (121) with the output from an I-Q Up-converter DDS (122). The I-Q Up-Converter DDS (122) has Cosine and Sine outputs that up-convert the I-Q MTA Radar Return Waveform from a DC center frequency to a positive frequency centered on the radar IF. A summing junction (123) combines the I and Q components (weighted by the Cosine and Sine components of the DDS (122) output) to form a real-valued digital data stream (124) that is the MTA Radar Return Waveform, centered at the Radar IF. This digital data stream is converted back to an analog signal in the DAC (125), and filtered through a DAC Reconstruction Filter (126) to produce an IF analog output (104) (RX IF signal 18 in FIG. 1) that is coupled back into the Radar Receiver 22.

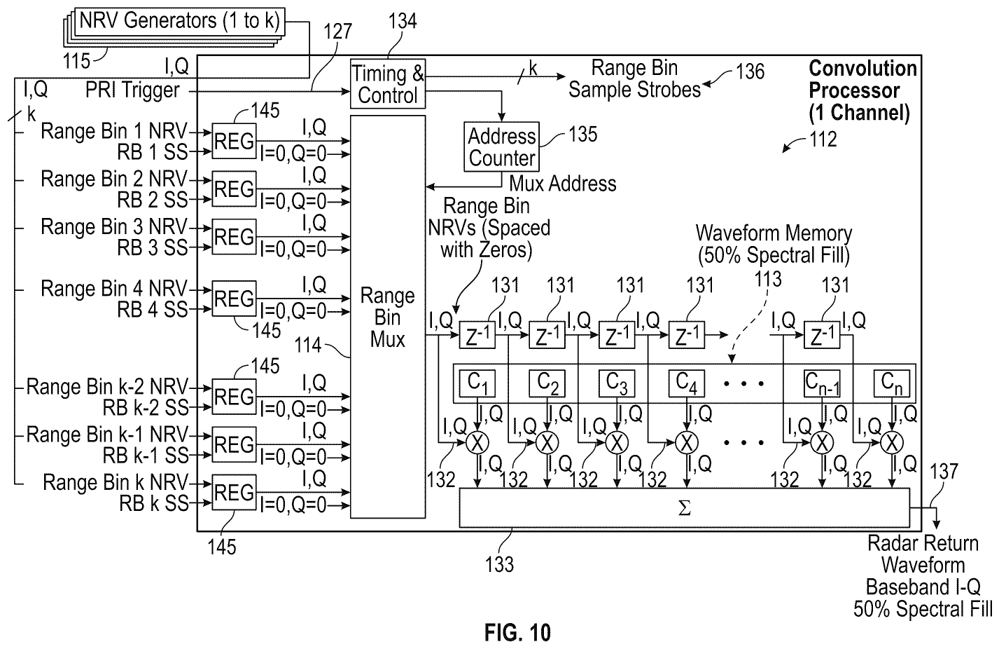

FIG. 10 provides detail of a Convolution Processor (112). The Waveform Memory (113) contains coefficients C1 through Cn, which are digitized samples (I & Q) of the radar waveform, sampled at a minimum integer rate of two I-Q samples per range bin. Clocking into memory is controlled by a Timing and Control function (134), which is initiated by a PRI Trigger (127). This function also generates Range Bin Sample Strobes (RB×SS) (136) which control the sampling of the NRV for each of k range bins, as well as an Address Counter (135) for the Range Bin Mux (114).

The I-Q outputs of the 1 through k NRV Generators (115), where k is the number of range bins, is highly dynamic, containing the contribution of multiple high frequency Dopplers. These dynamic signals are sampled (clocked into registers 45), at the appropriate instant in time, by the Range Bin Sample Strobe (RB×SS). These sampled NRV values are the input impulses for the Radar Return Synthesis Convolution.

The Range Bin Mux (114) multiplexes the 1 through k NRV Registers (145) into the convolution (131, 132, 133). The address advances at a minimum integer rate of 2 inputs per range bin, where one of those inputs is an NRV for the applicable range bin, and the remainder are zero (i.e., I=0; Q=0). The output of the Range Bin Mux (I-Q samples) drives a tapped delay line (131), where each tap is complex-multiplied (132) and summed together (133) to form the Radar Return Waveform (137) at baseband I-Q, with a minimum integer sample rate of two I-Q samples per range bin.

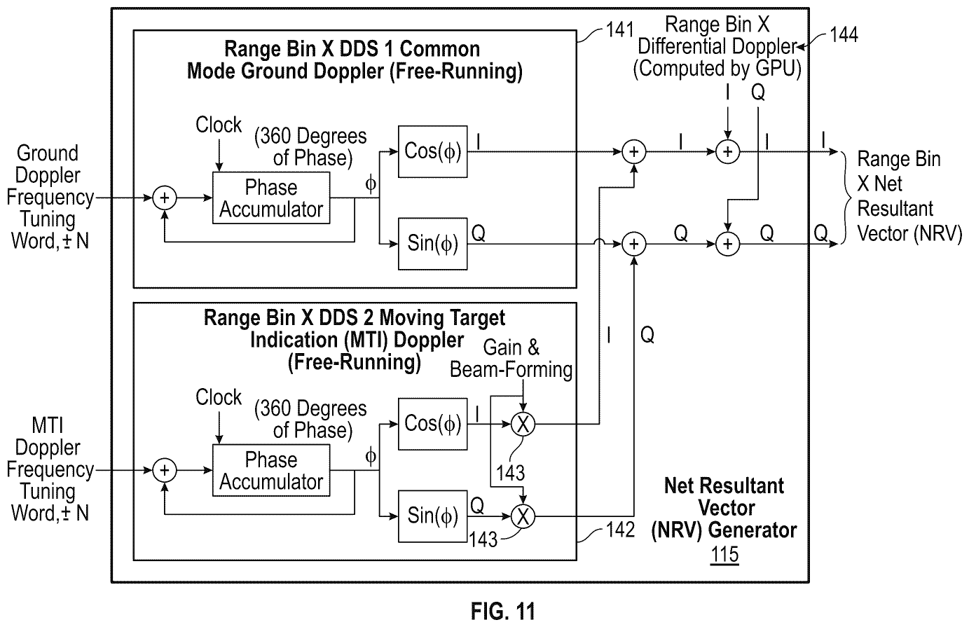

FIG. 11 provides detail of the NRV Generators (115). By definition, NRVs are the instantaneous aggregation of many individual I-Q vectors, each representing the reflection from certain entities (at a particular slant range) in the simulation. Most of those calculations are handled by a Graphics Processing Unit (GPU) (144). GPUs are ideally suited for executing, in parallel, a large multiplicity of similar equations, so the process of computing the current line of sight Doppler from each reflector in the range bin, rotating the vector of each reflector by an amount equal to phase rate×delta time, applying antenna beam forming (per above), then adding them all together (Vector summation), is a natural fit.

However, more processing capacity is required due to frame rate. The typical frame rate for graphics is 60 Hz (16.667 ms), which is quite slow for the dynamics involved in radar processing. For example, a Ku-Band (16 GHz) radar flying at Mach 1 will have a 32.5 KHz Doppler from a stationary reflector on the horizon (i.e. Az=El=0). In one 16.667 ms video frame, the Doppler will rotated through 542 cycles. While it is true that frame rates faster than 60 Hz can be achieved with modern GPUs, more processing is required to handle a nano-second scale frame rate required to capture fast line-of-sight Doppler.

One solution is to factor the problem using fast hardware such as Field Programmable Gate Array (FPGA)) to compute the Mean Doppler for a limited number of fast-moving entities, and a slower (but highly parallel) GPU to compute a larger multiplicity of Differential Dopplers (i.e., small deviations from the mean). This approach is illustrated in FIG. 11, wherein, in addition to the net I-Q value representing the summation of all Differential Doppler terms (144), there are at multiple (two in this example) fast-clocking, FPGA-based Direct Digital Synthesizers (DDS) (141, 142) to generate high speed Doppler. As shown, these include DDS phase accumulators with Cosine and Sine outputs that generate In-phase (I) and Quadrature (Q) components of the Doppler, respectively.

The first DDS (141) is allocated to generating Common M ode Ground Doppler for the range bin of interest. In other words, this is generating the average Doppler across one row of the range-Doppler map shown in FIG. 6, while the Differential Dopplers associated with every column of that row are computed in the GPU (144) and updated at a 60 Hz (or higher) frame rate.

The second DDS (142) is allocated to generating Doppler for discrete moving targets in the range bin of interest (Moving Target Indication; MTI). There may be multiple copies of the MTI Doppler DDS function (142) if multiple Moving Targets (Ground based or airborne) are possible in any given range bin. The MTI Doppler DDS function (142) includes a Gain and Beam-forming modulation function (143) that applies beamforming (per above). This function scales for all gain terms (Radar Cross Section, Range loss, antenna pattern directional gain, etc.) and also applies a phase inversion on the Az & El Difference Channels, depending on target location with respect to beam center.

Note that the Ground Common Mode Doppler DDS (141) has no similar function for Gain & Beam-forming (143). This is because it is not representing a single reflector (target) but is instead doing real-time calculation of the instantaneous phase of the average Ground Doppler in the range bin. The individual reflectors are computed as Differential Dopplers by the GPU (144) which must also perform Beam-forming on each individual I-Q vector prior to summation. In cases in which the antenna pattern is highly agile (e.g., an Airborne Electronically Scanned Array, A ESA), the required beamforming may be too fast to do in a GPU. In such cases, a GPU may still be used to advantage to compute the phase and amplitude of each individual reflector, but the Antenna Beam-forming and final summation may have to be done in fast hardware (i.e., FPGA).

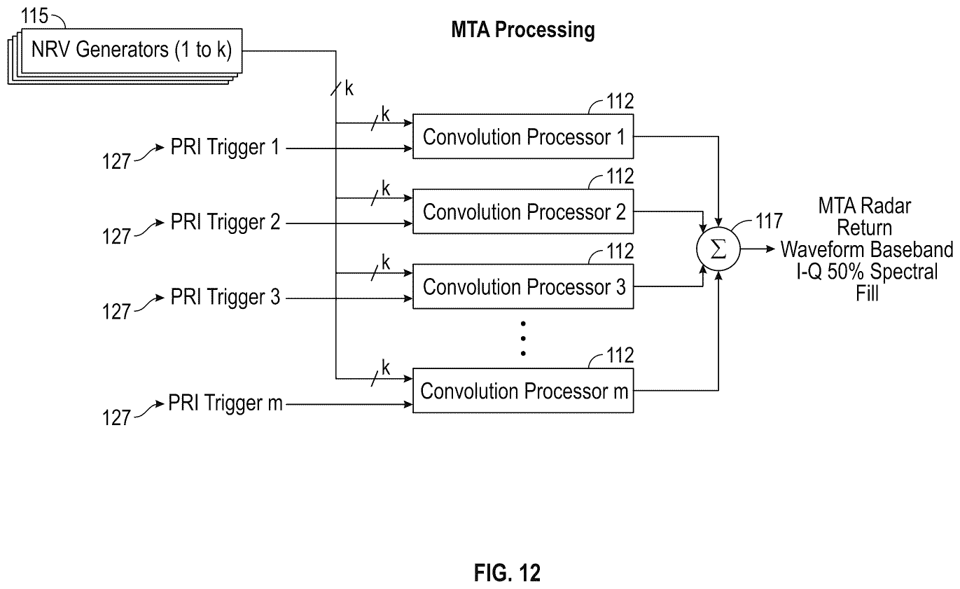

FIG. 12 provides details of the Multiple Time Around (MTA) Processing, which uses parallel (1 through m) Convolution Processors (112) to implement a “round-robin” response to each PRI Trigger (127). Each Convolution Processor 112 generates a radar return waveform, across all range bins, out to the maximum radar range, in response to one pulse from the Radar Exciter (20), as initiated by the applicable PRI Trigger (127).

When the radar transmits the next pulse (which occurs before the first Convolution Processor 112 is finished), the second Convolution Processor is assigned to generate the radar return waveform for that pulse. Thus, each radar pulse, in turn, is assigned to the next parallel Convolution Processor 112, in a “round-robin” manner. The amount of parallelism required is established by the maximum number of radar pulses, m, that are “In the air” at any given time. Thus, a total of m parallel Convolution Processors (112) are required. The outputs (Baseband I-Q waveforms at the Decimated sample rate) are summed (117) to produce the MTA Radar Return Waveform.

### Simulation Test Results

The remaining Figures present certain simulation results that illustrate the approach described herein.

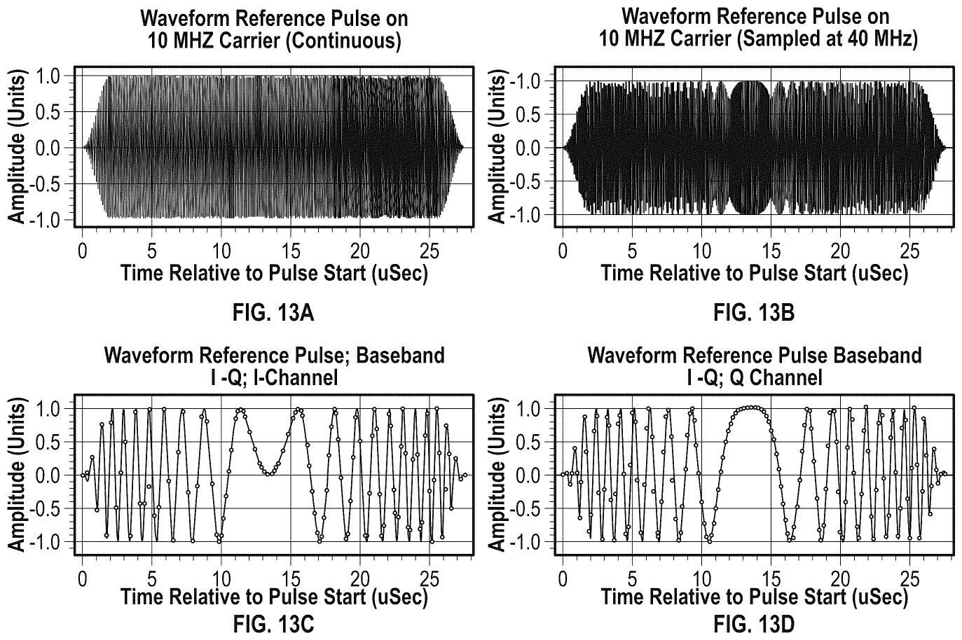

FIGS. 13A-13D illustrate the waveform capture process performed by the channel front-end circuitry (107-111 in FIG. 9). FIG. 13A shows the input unsampled IF waveform (10 MHz Carrier). FIG. 13B shows the IF Waveform (10 MHz Carrier) sampled at 40 MHz. FIGS. 13C and 13D show the I and Q channel digitized waveforms, respectively, after down-conversion to Baseband and decimation sampling to 2 Samples per Range Bin.

FIGS. 14A-14C illustrate the radar return synthesis process for a single discrete target in range bin 1, with 0° of phase shift. FIG. 14A shows baseband I-Q signal, and FIGS. 14B and 14C show the amplitude and phase respectively of the corresponding compressed waveform.

FIGS. 15A-15C are corresponding plots for a similar single target, at range bin 100, and with a phase shift of 180°.

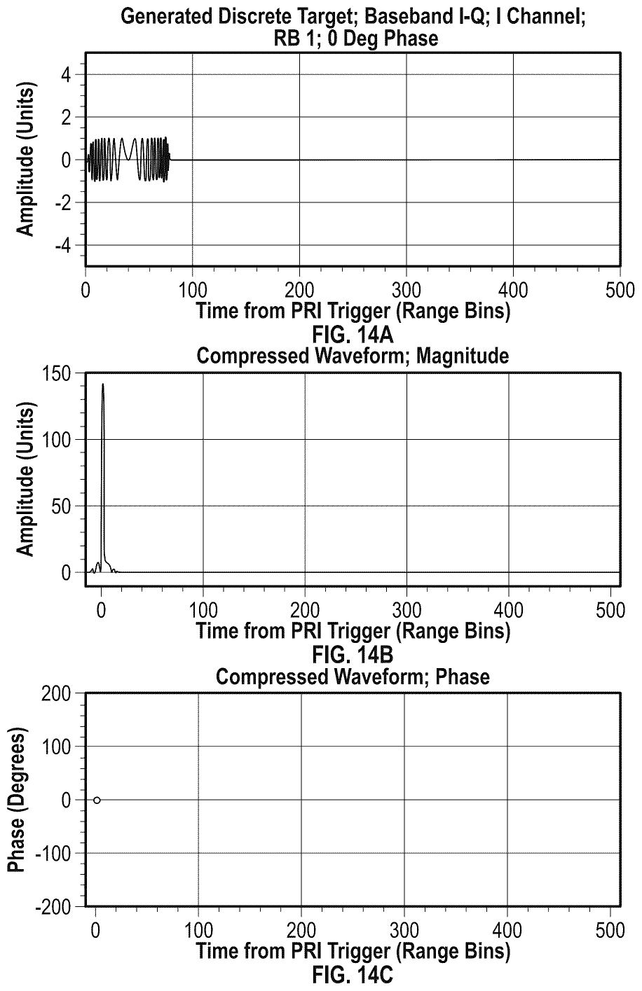

FIGS. 16A-16C are corresponding plots for a similar single target, at range bin 200, and with a phase shift of 60°.

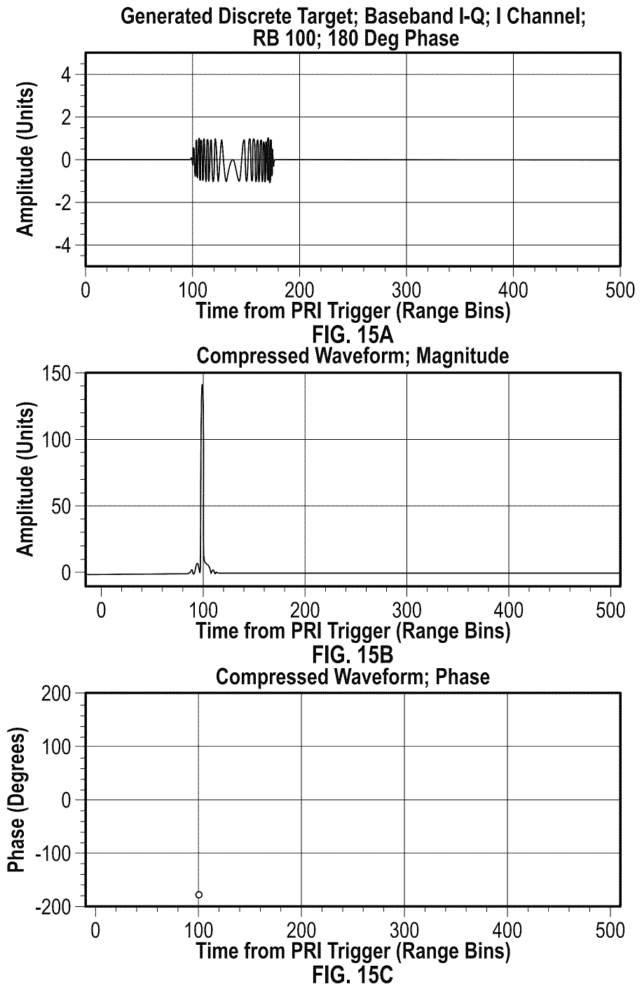

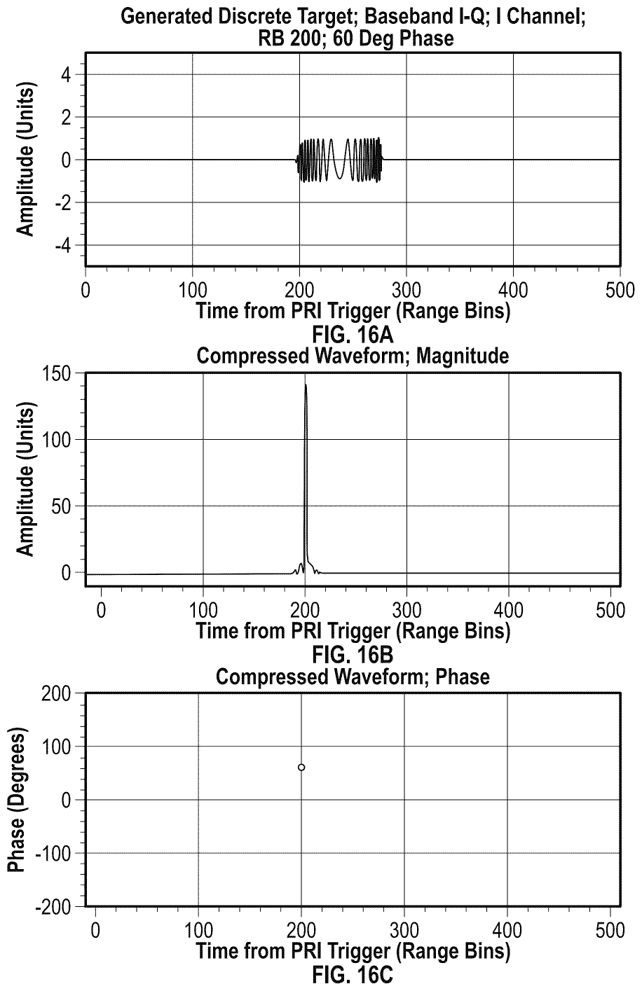

FIGS. 17A-17C are corresponding plots for a set of 5 discrete targets, in which the return waveforms overlap in time (range bins 1, 50, 100, 150 and 200). All 5 targets have unit magnitude, with phases of 0°, 60°, 90°, 180°, and 0°, respectively.

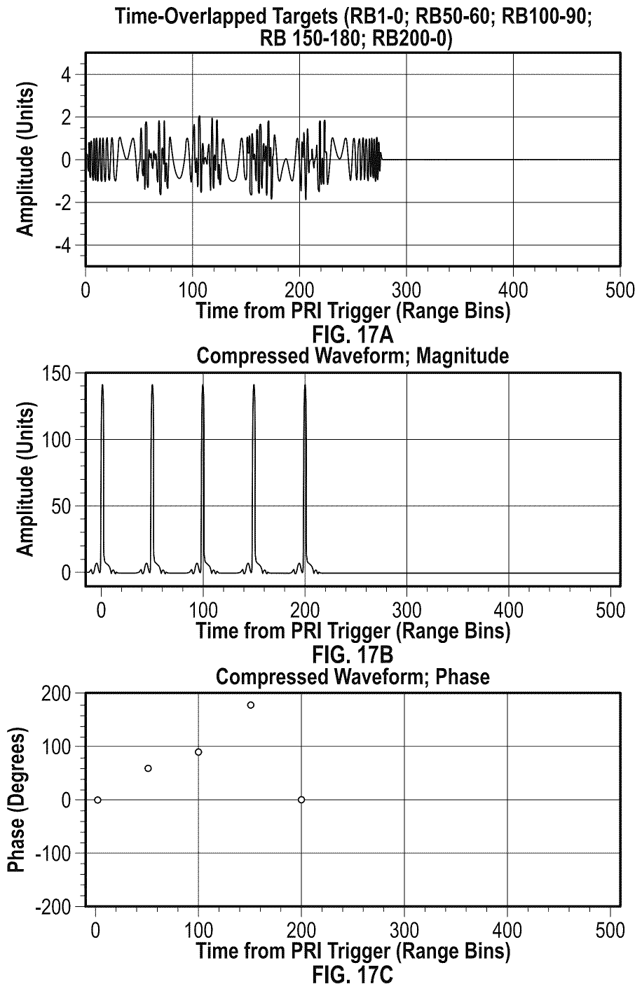

FIGS. 18A-18C illustrate the radar return synthesis process for a continuum of reflections (one in each range bin) configured to produce a test pattern of sinusoidal amplitude and linearly ramping phase. Although distributed returns are massively overlapped in time, the target return generators can cause any desired pattern of I-Q vectors (i.e., mag-phase) to appear in each radar range bin.

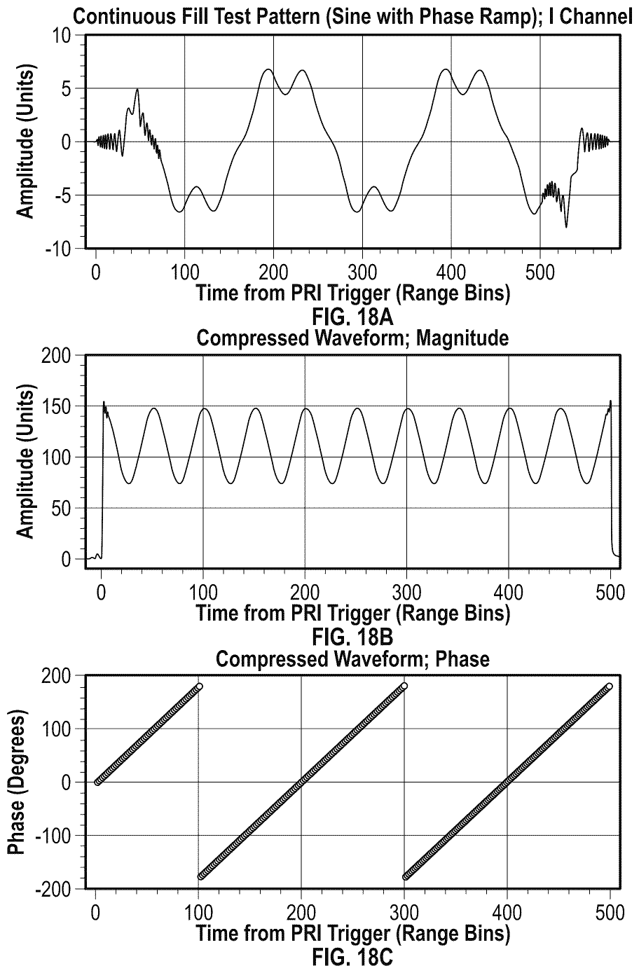

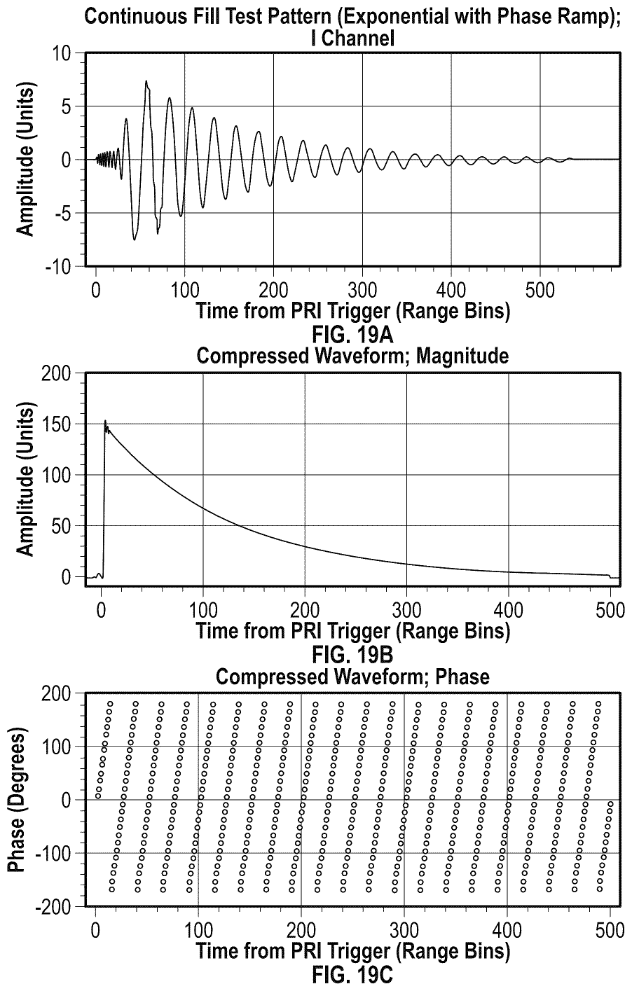

FIGS. 19A-19C are plots for a similar distributed return, but with decaying exponential amplitude and a faster version of linear ramping phase.

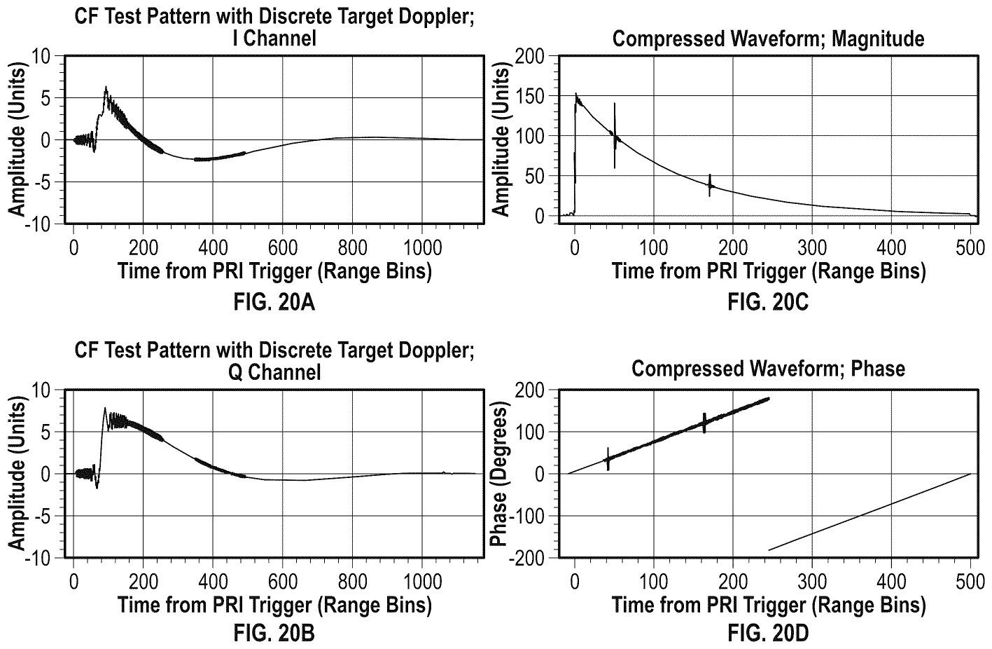

FIGS. 20A-20D are used to illustrate MTI Doppler with Distributed Target Synthesis, in this example having two discrete moving targets on a Test Pattern consisting of decaying exponential magnitude with a slow linear ramp in phase. FIGS. 20A and 20B show the expanded baseband radar return waveform (I and Q channels respectively). FIGS. 20C and 20D show the corresponding compressed pulse (Magnitude and Phase respectively).

It will be appreciated that the channel back-end circuitry (119-125 of FIG. 9) performs waveform generation as generally the inverse of the waveform generation described above with reference to FIGS. 13A-13D. Similar waveforms are generated for the up-sampling, conversion, and DAC conversion to generate the radar return signal 104.

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

While various embodiments of the invention have been particularly shown and described, it will be understood by those skilled in the art that various changes in form and details may be made therein without departing from the scope of the invention as defined by the appended claims.

What is claimed is:

1. A method of generating a synthesized intermediate-frequency (IF) radar return waveform provided to a radar receiver of a pulse-compression radar system during simulation-based operation thereof, comprising:
applying down-conversion processing to a transmit IF pulse signal of the pulse-compression radar system to generate a transmit-side baseband I-Q signal having I-Q phasor signal samples with in-phase and quadrature components;
applying I-Q convolutional processing to the transmit-side baseband I-Q signal and synthesized net resultant vector (NRV) range traces to produce a return-side baseband I-Q signal, the synthesized net resultant vector (NRV) range traces representing a predetermined simulated radar scene, the convolutional processing including range-bin multiplexing of I-Q samples of the NRV range traces and I-Q finite-impulse-response (FIR) filtering using the I-Q phasor signal samples as filter coefficients; and
applying up-conversion processing to the return-side baseband I-Q signal to produce the synthesized IF radar return waveform.

2. The method of claim 1, wherein, for each transmit IF pulse of the transmit IF pulse signal, the convolutional processing produces corresponding sets of signal samples for respective range bins of the range traces, each set including at most one non-zero I-Q signal sample and one or more zero-level samples, effective to provide sufficient frequency-domain separation from undesired alias images of the baseband I-Q signal for the up-conversion processing.

3. The method of claim 2, wherein each set of signal samples is a 2-sample set including the non-zero I-Q signal sample and one zero sample.

4. The method of claim 1, wherein the I-Q convolutional processing includes decimation processing having both an integer part and a fractional part to account for a non-integer relationship between an input analog-to-digital sampling rate and a range bin period of the pulse-compression radar system.

5. The method of claim 1, wherein the I-Q convolutional processing includes convolving an NRV for each range bin, from the NRV range traces, with the I-Q phasor signal samples stored in a waveform memory.

6. The method of claim 5, wherein the I-Q convolutional processing includes range-bin multiplexing of k NRV values from the NRV range traces, k being the number of range bins, to a single stream of NRV samples for the convolving with the I-Q phasor signal samples.

7. The method of claim 1, wherein the I-Q convolutional processing includes concurrent instances of processing for single radar pulses to provide multiple time around (MTA) processing for a sequence of radar pulses that are in flight during a single round-trip time for a radar pulse.

8. The method of claim 1, wherein the convolutional processing is factored into first, common-mode, processing for all differential Doppler signals and one or more second, discrete moving target, processing for respective specific moving targets to be represented in the return-side baseband I-Q signal.

9. A radar stimulation system for use in generating a synthesized intermediate-frequency (IF) radar return waveform for a radar receiver of a pulse-compression radar system during simulation-based operation thereof, the radar stimulation system including a multi-channel radar return generator having multiple instances of channel circuitry for respective beam-forming channels of the pulse-compression radar system, each instance of channel circuitry being a complex digital signal processor including:
down-conversion processing circuitry to apply down-conversion processing to a transmit IF pulse signal of the pulse-compression radar system to generate a transmit-side baseband I-Q signal having I-Q phasor signal samples with in-phase and quadrature components;
a set of convolution processors to apply I-Q convolutional processing to the transmit-side baseband I-Q signal and synthesized net resultant vector (NRV) range traces to produce a return-side baseband I-Q signal, the synthesized net resultant vector (NRV) range traces representing a predetermined simulated radar scene, the convolutional processing including range-bin multiplexing of I-Q samples of the NRV range traces and I-Q finite-impulse-response (FIR) filtering using the I-Q phasor signal samples as filter coefficients; and
up-conversion processing circuitry to apply up-conversion processing to the return-side baseband I-Q signal to produce the synthesized IF radar return waveform.

10. The radar stimulation system of claim 8, wherein, for each transmit IF pulse of the transmit IF pulse signal, the convolutional processing produces corresponding sets of signal samples for respective range bins of the range traces, each set including at most one non-zero I-Q signal sample and one or more zero-level samples, effective to provide sufficient frequency-domain separation from undesired alias images of the baseband I-Q signal for the up-conversion processing.

11. The radar stimulation system of claim 9, wherein each set of signal samples is a 2-sample set including the non-zero I-Q signal sample and one zero sample.

12. The radar stimulation system of claim 8, wherein the I-Q convolutional processing includes decimation processing having both an integer part and a fractional part to account for a non-integer relationship between an input analog-to-digital sampling rate and a range bin period of the pulse-compression radar system.

13. The radar stimulation system of claim 8, wherein the I-Q convolutional processing includes convolving an NRV for each range bin, from the NRV range traces, with the I-Q phasor signal samples stored in a waveform memory.

14. The radar stimulation system of claim 13, wherein the I-Q convolutional processing includes range-bin multiplexing of k NRV values from the NRV range traces, k being the number of range bins, to a single stream of NRV samples for the convolving with the I-Q phasor signal samples.

15. The radar stimulation system of claim 8, wherein the I-Q convolutional processing includes concurrent instances of convolutional processors for respective single radar pulses to provide multiple time around (MTA) processing for a sequence of radar pulses that are in flight during a single round-trip time for a radar pulse.

16. The radar stimulation system of claim 8, wherein each of the convolution processors includes first processing circuitry for common-mode processing all differential Doppler signals and one or more instances of second processing circuitry applying discrete moving target processing for respective specific moving targets to be represented in the return-side baseband I-Q signal.
